(19) United States
(12) Patent Application Publication
(10) Pub. No.: US 2007/0211700 A1
(43) Pub. Date: Sep. 13, 2007

(54) Network device and method for retrieving VoIP configuration parameters

(75) Inventors: Cheng-Yi Hsieh, Shenzhen (CN); Yu-Cheng Lin, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,869

(22) Filed: Oct. 16, 2006

(30) Foreign Application Priority Data
Mar. 10, 2006 (TW) 095108173

(51) Int. Cl. H04L 12/66

(52) U.S. Cl. 370/356

(57) ABSTRACT

A network device (10) for retrieving voice over Internet protocol (VoIP) configuration parameters includes an automatic dialing module, an asymmetric digital subscriber line (ADSL) module, a connection determining module, a sending module, and a parsing module. The automatic dialing module provides automatic dialing connections. The ADSL module provides ADSL connections. The connection determining module determines whether an automatic dialing connection and an ADSL connection of the network device are normal. The sending module communicates with the connection determining module and a server for sending a data retrieval request to the server. The response determining module communicates with the server for determining whether a response received from the server is correct. The parsing module communicates with the response determining module and the server for receiving data sent by the server corresponding to the data retrieval request and parsing the data to determine VoIP configuration parameters.

### 1. FIELD OF THE INVENTION

The invention relates to network devices, and particularly to an integrated access device and a method for retrieving voice over Internet protocol (VoIP) configuration parameters.

### 2. DESCRIPTION OF RELATED ART

Voice over Internet Protocol (VoIP) configuration parameters of integrated access devices (IAD) are provided by remote servers, that is, the IADs need to retrieve VoIP configuration parameters from the remote server. IADs commonly retrieve VoIP configuration parameters via dynamic host configuration protocol (DHCP), therefore, there must exist DHCP servers in networks of the IADs.

However, networks of the IADs include two types: one type including DHCP servers and Hypertext transfer protocol (HTTP) servers and the other one only including HTTP servers. If networks of the IADs do not include DHCP servers, the IADs cannot retrieve VoIP configuration parameters, thereby failing to provide VoIP services.

### SUMMARY OF THE INVENTION

An embodiment of the invention provides a network device for retrieving voice over Internet protocol (VoIP) configuration parameters. The network device includes an automatic dialing module, an asymmetric digital subscriber line (ADSL) module, a connection determining module, a sending module, and a response determining module. The automatic dialing module is for providing automatic dialing connections. The ADSL module is for providing ADSL connections. The connection determining module communicates with the automatic dialing module and the ADSL module for determining whether an automatic dialing connection and an ADSL connection of the network device are normal. The sending module communicates with the connection determining module and a server communicating with the network device, for sending a data retrieval request to the server when the connection determining module determines that the automatic dialing connection and the ADSL connection of the network device is normal. The response determining module communicates with the server for determining whether a response received from the server is correct. The parsing module communicates with the response determining module and the server for receiving data sent by the server corresponding to the data retrieval request and parsing the data to determine VoIP configuration parameters when the response is correct.

Another embodiment of the invention provides a method for retrieving voice over Internet protocol (VoIP) configuration parameters, for use in a network device. The method includes activating an automatic dialing module; determining whether an automatic dialing connection and an asymmetric digital subscriber line (ADSL) connection of the network device are normal by a connection determining module; sending a data retrieval request to a server communicating with the network device if the automatic dialing connection and the ADSL connection are normal; determining whether a response received from the server is correct; and receiving data sent by the server corresponding to the data retrieval request, and parsing the data to determine VoIP configuration parameters.

Other advantages and novel features will become more apparent from the following detailed description when taken in conjunction with the accompanying drawings.

### BRIEF DESCRIPTION OF THE DRAWINGS

FIG. 1 is a schematic diagram of a network device of an exemplary embodiment of the invention.

FIG. 2 shows a flowchart of a method for retrieving voice over Internet protocol (VoIP) configuration parameters of another exemplary embodiment of the invention.

### DETAILED DESCRIPTION OF THE INVENTION

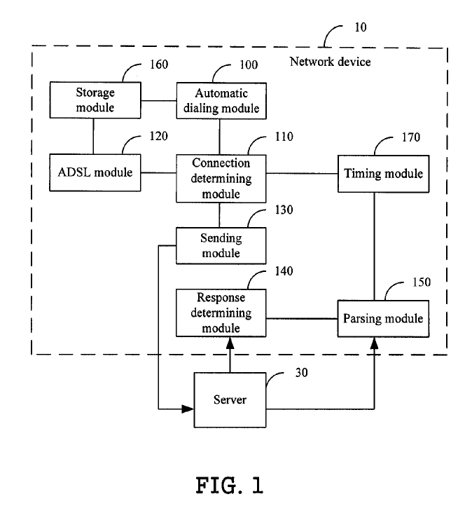

FIG. 1 is a schematic diagram of a network device 10 of an exemplary embodiment of the invention. The network device 10 communicates with a server 30, for retrieving voice over Internet protocol (VoIP) configuration parameters. In the exemplary embodiment, the network device 10 includes a modem, the server 30 includes a hypertext transfer protocol (HTTP) server, and the network device 10 can retrieve VoIP configuration parameters from the server 30 via HTTP.

The network device 10 includes an automatic dialing module 100, a connection determining module 110, an asymmetric digital subscriber line (ADSL) module 120, a sending module 130, a response determining module 140, and a parsing module 150.

The automatic dialing module 100 is for providing automatic dialing connections. In the exemplary embodiment, the automatic dialing module 100 includes a point-to-point protocol over Internet (PPPoE) module for providing PPPoE connections. The ADSL module 120 is for providing ADSL connections. The connection determining module 110 is connected to the automatic dialing module 100 and the ADSL module 120, and is for determining whether an automatic dialing connection and an ADSL connection of the network device 10 are normal. The sending module 130 communicating with the connection determining module 110 and the server 30 is for sending a data retrieval request to the server 30 when the connection determining module 110 determines the automatic dialing connection and the ADSL connection are normal. In the exemplary embodiment, the data retrieval request may be an HTTP request.

When the server 30 receives the data retrieval request sent by the network device 10, it first sends a response to the network device 10, and then sends data corresponding to the data retrieval request to the network device 10. In the exemplary embodiment, the data includes VoIP configuration parameters.

The response determining module 140 communicates with the server 30 for determining whether the response received from the server 30 is correct. In the exemplary embodiment, the response may include three digits with a first one defining response types. The first digit may include digits 1, 2, 3, 4, and 5. The digit 1 indicates an informational type, that is, the data retrieval request is received, and further processes can continue. The digit 2 indicates a successful type, that is, the data retrieval request is successfully received, understood, and accepted. The digit 3 indicates a redirection type, that is, further actions are needed to complete the data retrieval request. The digit 4 indicates a client error type, that is, the data retrieval request includes wrong syntax or cannot be implemented. The digit 5 indicates a server error type, that is, the server 30 cannot implement the valid data retrieval request. In the exemplary embodiment, the other two digits of the response are stochastic. The response determining module 140 determines whether the response is correct according to the first digit of the response. For example, if a received response by the response determining module 140 is 200, the response determining module 140 determines that the response is correct. In alternative embodiments, the response determining module 140 further determines whether responses from the server 30 are received.

The parsing module 150 communicates with the response determining module 140 and the server 30, and is used for receiving the data corresponding to the data retrieval request sent by the server 30 and parsing the data to determine the VoIP configuration parameters when the response determining module 140 determines that the response is correct. In the exemplary embodiment, the data sent by the server 30 are extensible markup language (XML) files. In alternative embodiments, the parsing module 150 further configures the network device 10 according to the VoIP configuration parameters to provide VoIP service.

The network device 10 further includes a storage module 160 connected to the automatic dialing module 100 and the ADSL module 120 for saving ADSL connection statuses and automatic dialing connection statuses. In the exemplary embodiment, the storage module 160 includes a system log. The automatic dialing module 100 further reads the automatic dialing connection statuses from the storage module 160, and the ADSL module 120 further reads the ADSL connection statues from the storage module 160. In the exemplary embodiment, the automatic dialing module 100 and the ADSL module 120 respectively include an application program interface (API) for reading the automatic dialing connection statuses and the ADSL connection statuses from the storage module 160. The connection determining module 110 determines whether the automatic dialing connection and the ADSL connection of the network device 10 are normal according to the read automatic dialing connection statuses and ADSL connection statuses.

The network device 10 further includes a timing module 170 connected to the connection determining module 110 and the parsing module 150. The timing module 170 is used for timing and reactivating the connection determining module 110 after a first predetermined period to redetermine whether the automatic dialing connection and the ADSL connection of the network device 10 are normal when the connection determining module 110 determines that the automatic dialing connection and the ADSL connection are abnormal, and for timing and reactivating the connection determining module 110 after a second predetermined period to redetermine whether the automatic dialing connection and the ADSL connection of the network device 10 are normal after the parsing module 150 configures the network device 10. In the exemplary embodiment, the first predetermined period may be 5 seconds, and the second predetermined period may be 3600 seconds, both set by a user of the network device 10. In the exemplary embodiment, the timing module 170 generates an activating signal to activate the connection determining module 110.

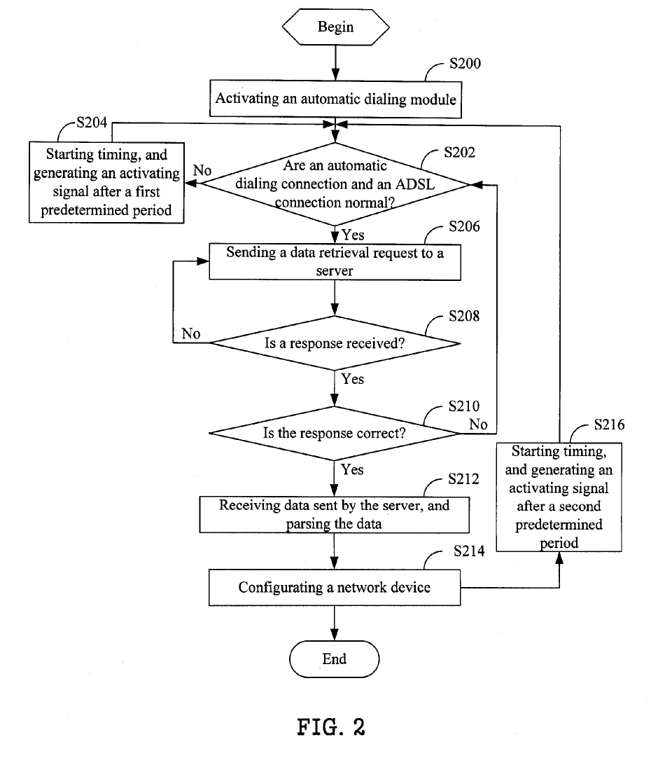

FIG. 2 is a method for retrieving VoIP configuration parameters of an exemplary embodiment of the invention. At first the network device 100 is turned on. In step S200, the automatic dialing module 100 is activated. In step S202, the connection determining module 110 determines whether the signal communicable connection, i.e., an ADSL connection and an automatic dialing connection of the network device 10 are normal. If abnormal, then in step S204, the timing module 170 starts timing, generates an activating signal after the first predetermined period, which returns the process to step S202, and sends the activating signal to the connection determining module 110 to determine whether the ADSL connection and the automatic dialing connection are normal. In the exemplary embodiment, the first predetermined period may be 5 seconds.

If the ADSL connection and the automatic dialing connection are normal, in step S206, the sending module 130 sends a data retrieval request to the server 30.

In step S208, the response determining module 140 determines whether a response is received from the server 30. If no response is received, the process returns to step S206, and the sending module 130 resends the data retrieval request to the server 30. If the response determining module 140 receives the response from the server 30, in step S210, the response determining module 140 determines whether the response is correct. If the response is not correct, the process returns to step S202.

If the response is correct, in step S212, the parsing module 150 receives data sent by the server 30, and parses the data to determine VoIP configuration parameters. In step S214, the parsing module 150 configures the network device 10 to provide VoIP services according to the VoIP configuration parameters.

In step S216, the timing module 170 starts timing, generates an activating signal after a second predetermined period, which returns the process back to step S202, and sends the activating signal to the connection determining module 110 to determine whether the ADSL connection and the automatic dialing connection are normal. In the exemplary embodiment, the second predetermined period may be 3600 seconds.

The network device 10 is able to retrieve the VoIP configuration data from the server 30 via the HTTP, avoiding failure to provide VoIP services when there is no DHCP server in a network of the network device 30.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device, for retrieving voice over Internet protocol (VoIP) configuration parameters, comprising:
an automatic dialing module, for providing automatic dialing connections;
an asymmetric digital subscriber line (ADSL) module, for providing ADSL connections;
a connection determining module communicating with the automatic dialing module and the ADSL module, for determining whether an automatic dialing connection and an ADSL connection of the network device are normal;
a sending module communicating with the connection determining module and a server communicating with the network device, for sending a data retrieval request to the server when the connection determining module determines that the automatic dialing connection and the ADSL connection of the network device are normal;
a response determining module communicating with the server, for determining whether a response received from the server is correct; and
a parsing module communicating with the response determining module and the server, for receiving data sent by the server corresponding to the data retrieval request and parsing the data to determine VoIP configuration parameters when the response is correct.

2. The network device of claim 1, further comprising a storage module communicating with the ADSL module, for saving ADSL connection statuses of the network device.

3. The network device of claim 2, wherein the storage module also communicates with the automatic dialing module, and saves automatic dialing connection statuses of the network device.

4. The network device of claim 3, wherein the automatic dialing module further reads the automatic dialing connection statuses saved in the storage module, and the ADSL module further reads the ADSL connection statuses saved in the storage module.

5. The network device of claim 4, wherein the connection determining module determines whether the automatic dialing connection and the ADSL connection are normal according to the read automatic dialing connection statuses and the read ADSL connection statuses.

6. The network device of claim 1, wherein the response determining module further determines whether the response is received from the server.

7. The network device of claim 1, wherein the automatic dialing module includes a point-to-point protocol over Internet (PPPoE) module for providing PPPoE connections.

8. The network device of claim 7, wherein the data retrieval request is a hypertext transfer protocol (HTTP) request, the server is a HTTP server, and the data sent by the server are extensible markup language (XML) files.

9. The network device of claim 1, wherein the parsing module further configures the network device to provide VoIP services according to the VoIP configuration parameters.

10. The network device of claim 9, further comprising a timing module communicating with the connection determining module, for timing and reactivating the connection determining module after a first predetermined period to redetermine whether the automatic dialing connection and the ADSL connection of the network device are normal when the connection determining module determines that the automatic dialing connection and the ADSL connection are abnormal.

11. The network device of claim 10, wherein the timing module further communicates with the parsing module for timing and reactivating the connection determining module after a second predetermined period to redetermine whether the automatic dialing connection and the ADSL connection of the network device are normal after the parsing module configures the network device.

12. A method for retrieving voice over Internet protocol (VoIP) configuration parameters, for use in a network device, comprising:
activating an automatic dialing module;
determining whether an automatic dialing connection and an asymmetric digital subscriber line (ADSL) connection of the network device are normal by a connection determining module;
sending a data retrieval request to a server communicating with the network device if the automatic dialing connection and the ADSL connection are normal;
determining whether a response received from the server is correct; and
receiving data sent by the server corresponding to the data retrieval request, and parsing the data to determine VoIP configuration parameters.

13. The method for retrieving VoIP configuration parameters of claim 12, further comprising steps of:
determining whether the response is received from the server.

14. The method for retrieving VoIP configuration parameters of claim 13, further comprising steps of:
resending the data retrieval request to the server if no response is received.

15. The method for retrieving VoIP configuration parameters of claim 12, further comprising steps of:
redetermining whether the ADSL connection and the automatic dialing connection of the network device are normal if the response is wrong.

16. The method for retrieving VoIP configuration parameters of claim 12, further comprising steps of:
configuring the network device according to the VoIP configuration parameters to provide VoIP services.

17. The method for retrieving VoIP configuration parameters of claim 16, further comprising steps of:
starting timing, generating an activating signal after a first predetermined period, and sending the activating signal to the connection determining module if the ADSL connection and the automatic dialing connection of the network device are abnormal.

18. The method for retrieving VoIP configuration parameters of claim 17, further comprising steps of:
starting timing, generating an activating signal after a second predetermined period, and sending the activating signal to the connection determining module after the network device is configured.

19. A method for retrieving voice over Internet protocol (VoIP) configuration parameters applicable in a network device, comprising the steps of:
establishing a signal communicable connection of a network device;
sending a hypertext transfer protocol (HTTP) data retrieval request to a server signally communicable with said network device through said signal communicable connection;
retrieving extensible markup language (XML) data from said server when said server responds to said HTTP request of said network device; and
parsing said XML data to acquire VoIP configuration parameters for said network device.

20. The method of claim 19, further comprising the step of starting timing for a predetermined period to reestablish said signal communicable connection when said signal communicable connection is not successfully established in said establishing step.
